(19) United States
(12) Patent Application Publication
(10) Pub. No.: US 2025/0224743 A1
(43) Pub. Date: Jul. 10, 2025

(54) ROBOT CONTROL SYSTEM, CONTROL APPARATUS, MOBILE ROBOT, ROBOT CONTROL METHOD, AND PROGRAM

(71) Applicant: NEC Corporation, Minato-ku, Tokyo (JP)

(72) Inventors: Taichi KUMAGAI, Tokyo (JP); Hiroshi YOSHIDA, Tokyo (JP); Shinya YASUDA, Tokyo (JP)

(73) Assignee: NEC Corporation, Minato-ku, Tokyo (JP)

(21) Appl. No.: 17/604,496

(22) PCT Filed: Apr. 7, 2020
(86) PCT No.: PCT/JP2020/015682

§ 371 Date: Oct. 18, 2021

(30) Foreign Application Priority Data
Apr. 23, 2019 (JP) 2019-081811

(51) Int. Cl. G05D 1/698; G05D 101/00

(52) U.S. Cl. CPC G05D 1/6987; G05D 2101/22

(57) ABSTRACT

To provide a robot control system, etc. capable to contributing to reducing costs and causing to synchronize movements between robots. The system comprises: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. The control apparatus executes processings of: generating control information including information related to a current location and an intermediate destination of each of the plurality of mobile robots at the same timing based on information from the sensor apparatus; and transmitting the generated control information to each of the plurality of mobile robots.

### TECHNICAL FIELD

### Description of Related Application

The present invention is based on claiming priority of Japanese patent application: JP2019-081811 (filed on Apr. 23, 2019), and the entire contents of the present application shall be incorporated and stated in the present application by reference thereto.

The present invention relates to a robot control system, a control apparatus, a mobile robot, a robot control method, and a program.

### BACKGROUND ART

In recent years, under a background of labor shortage, an introduction of mobile robots that transport freights (transport objects) is progressing at sites such as logistics. Also, freights to be handled become a variety of types and amount, and in mobile robots, versatility is required in response to changes in work content and layout in a warehouse. On the other hand, an introduction cost is increasing due to the high functionality of mobile robots and the accompanying new introduction of dedicated trolley, storage equipment, ancillary facilities, etc.

As a method of ensuring a versatility of the mobile robot and reducing an introduction cost, there is a method (robot cooperative transport method) of transporting a freight by cooperating (collaborating) a plurality of mobile robots. In the robot cooperative transport method, by cooperating a plurality of mobile robots having simple functions, it is possible to correspond to freights of various shapes and weights, and by unifying mobile robots, it is possible to perform easily failure handling and maintenance. Also, in the robot cooperative transport method, since it is necessary to maintain a positional relationship between the mobile robots so as not to drop freights, it is important to move while maintaining a synchronization between the mobile robots. As systems that use the robot cooperative transport method, there are the following systems.

For example, in a system described in Patent Literature (PTL) 1, by providing position error absorption mechanisms on first and second robots, respectively; estimating an external force acting on the first and second robots; and controlling the first and second robots so that the estimated external force becomes zero, thereby, it is possible to perform cooperative transport work of long heavy objects.

Also, in a system described in PTL 2, each trolley (robot) periodically wirelessly broadcasts its own self-information; and each slave autonomously controls a movement of each of its omnidirectional wheels to autonomously change its position, travelling direction, and travelling speed, based on each of self-information broadcast from a master and one or more other slaves, thereby, it is possible to transport at low cost without limitation in a freight shape (for example, long freight) and usage environment (for example, narrow aisles).

In a system described in PTL 3, by acquiring actual acceleration information of the other vehicle due to inter-vehicle communication; and controlling an acceleration/deceleration of the own vehicle (follower vehicle robot) according to the acquired actual acceleration information, it is possible to cause to accurately follow the own vehicle to another vehicle (leader vehicle robot) so that an inter-vehicle distance does not become shorter than necessary.

In a system described in PTL 4, by monitoring a position and direction of each of robot apparatuses on an operation field; communicating with each of the robot apparatuses; and controlling a synchronous and cooperative operation due to each of the robot apparatuses based on a monitoring result and state information of the robot apparatus, acquired by communication from each of the robot apparatuses, it is possible to achieve a specific purpose as a whole.

In a system described in PTL 5, a slave robot creates a slave motion plan and sends it to a master robot; the master robot modifies a master motion plan and the slave motion plan, respectively, and creates the modified master motion plan and the modified slave motion plan; the modified slave motion plan is transmitted to the slave robot; the master robot executes the modified master motion plan and moves; and the slave robot executes the modified slave motion plan and moves, thereby, even if surrounding conditions of the robot are unknown, it is possible to perform a cooperated movement of a plurality of robots without requiring high processing power to the robots.

### CITATION LIST

### Patent Literature

[PTL 1] JP6151159B
[PTL 2] JP5588714B
[PTL 3] JP6265191B
[PTL 4] JP2006-954A
[PTL 5] JP2016-16475A

### SUMMARY

### Technical Problem

The following analysis is given by the inventors of the present application.

However, in the system described in PTL 1, although position information is exchanged between robots, since the sampling timing is different for each of robots, there is a possibility that synchronization can not be established well. Also, in the system described in PTL 1, since the mechanism is complex, not only a cost of the robot increases, but also there is a possibility that failures increase and maintenance costs increase.

In the system described in PTL 2, since the control is performed after receiving the information of the other vehicle, not only the control timing is delayed, but also there is a possibility that errors of a movement amount and a movement direction are accumulated and the synchronization is not good by an influence of a unevenness of a floor or the like.

In the system described in PTL 3, since the control is performed after receiving the information of the leader vehicle, not only the control timing is delayed, but also when the leader vehicle is not at a constant speed, there is a possibility that a control fluctuation is large near a target value (inter-vehicle distance) and the synchronization is not well established.

In the system described in PTL 4, since the sampling timings of a monitoring result from the system and state information from other robot apparatus are different, there is a possibility that the synchronization is not well established.

In the system described in PTL 5, since creation timings of the slave motion plan and the master motion plan are different, there is a possibility that the synchronization is not good.

It is a main object of the present invention to provide a robot control system, a control apparatus, a mobile robot, a robot control method, and a program that it is possible to contribute to reducing costs and moving while maintaining synchronization between robots.

### Solution to Problem

A robot control system according to a first aspect is a robot control system comprising: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. The control apparatus executes processings of: generating control information including information related to a current location and an intermediate destination of each of the plurality of mobile robots at the same timing based on information from the sensor apparatus; and transmitting the generated control information to each of the plurality of mobile robots. A leader robot in the plurality of mobile robots executes processings of: calculating a control value of the leader robot by using the information related to the current location and the intermediate destination of the leader robot in the control information; and controlling a movement of the leader robot based on the calculated control value of the leader robot. A follower robot(s) other than the leader robot in the plurality of mobile robots executes processings of: calculating a control value of the leader robot by using the information related to the current location and the intermediate destination of the leader robot in the control information; calculating a control value of the follower robot(s) by using the calculated control value of the leader robot and the information related to the current location and the intermediate destination of the follower robot(s) in the control information; and controlling a movement of the follower robot(s) so as to follow the leader robot based on the calculated control value of the follower robot(s).

A robot control system according to a second aspect is connected to a plurality of mobile robots is a robot control system comprising: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. The control apparatus executes processings of: calculating a control value of a leader robot in the plurality of mobile robots by using information related to a current location and an intermediate destination of each of the plurality of mobile robots at the same timing based on information from the sensor apparatus; calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

A control apparatus according to a third aspect is a control apparatus in a robot control system comprising: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. The control apparatus executes processings of: generating control information including information related to a current location and an intermediate destination of each of the plurality of mobile robots at the same timing based on information from the sensor apparatus; and transmitting the generated control information to each of the plurality of mobile robots.

A mobile robot according to a fourth aspect is a mobile robot in a robot control system comprising: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. When the mobile robot becomes a follower robot(s) other than a leader robot in the plurality of mobile robots, the mobile robot executes processings of: acquiring control information including information related to a current location and an intermediate destination of each of the plurality of mobile robots at the same timing based on the information from the sensor apparatus, from the control apparatus; calculating a control value of the leader robot by using the information related to the current location and the intermediate destination of the leader robot in the control information; calculating a control value of the follower robot(s) by using the calculated control value of the leader robot and the information related to the current location and the intermediate destination of the follower robot(s) in the control information; and controlling a movement of the follower robot(s) so as to follow the leader robot based on the calculated control value of the follower robot(s).

A robot control method according to a fifth aspect is a robot control method of controlling a plurality of mobile robots by using a robot control system comprising: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area. The method comprises: in the control apparatus, generating control information including information related to a current location and an intermediate destination of each of the plurality of mobile robots at the same timing based on information from the sensor apparatus; in the control apparatus, transmitting the generated control information to each of the plurality of mobile robots; in a leader robot in the plurality of mobile robots, calculating a control value of the leader robot by using the information related to the current location and the intermediate destination of the leader robot in the control information; in the leader robot, controlling a movement of the leader robot based on the calculated control value of the leader robot; in a follower robot other than the leader robot in the plurality of mobile robots, calculating a control value of the leader robot by using the information related to the current location and the intermediate destination of the leader robot in the control information; in the follower robot(s), calculating a control value of the follower robot(s) by using the calculated control value of the leader robot and the information related to the current location and the intermediate destination of the follower robot(s) in the control information; and in the follower robot(s), controlling a movement of the follower robot(s) so as to follow the leader robot based on the calculated control value of the follower robot(s).

A program according to a sixth aspect is a program causing a control apparatus in a robot control system to execute processings, wherein the robot control system comprises: a plurality of mobile robots; the control apparatus that is communicably connected to the plurality of mobile robots and manages and controls the plurality of mobile robots; and a sensor apparatus that is communicably connected to the control apparatus and senses the plurality of mobile robots in a predetermined area. The program causes the control apparatus to execute the processings: generating control information including information related to a current location and an intermediate destination of each of the plurality of mobile robots at the same timing based on information from the sensor apparatus; and transmitting the generated control information to each of the plurality of mobile robots.

The program can be recorded on a computer-readable storage medium. The storage medium may be a non-transient such as a semiconductor memory, a hard disk, a magnetic recording medium, or an optical recording medium. Also, in the present disclosure, it is also possible to implement it as a computer program product. The program is input to a computer apparatus from an input device or from outside via a communication interface; is stored in a storage device; causes a processor to drive according to predetermined steps or processings; can cause to display processing results thereof, including an intermediate state via a display device step by step as necessary; or can cause to communicate with outside via a communication interface. The computer apparatus for that purpose typically comprises: for example, a processor; a storage device; an input device; a communication interface; and, if necessary, a display device, that can be connected to each other via a bus.

### Effects of Invention

According to the first to fifth aspects, it is possible to contribute to reducing costs and causing to synchronize movements between robots.

### BRIEF DESCRIPTION OF THE DRAWINGS

FIG. 1 is a block diagram schematically showing a configuration of a robot control system according to a first example embodiment.

FIG. 2 is an image diagram schematically showing a state when a transport object is transported by using the robot control system according to the first example embodiment.

FIG. 3 is an image diagram for explaining an example of a calculation method of a control value of a drive part of a mobile robot in the robot control system according to the first example embodiment.

FIG. 4 is a flowchart schematically showing operations of a position detection part of a sensor apparatus in the robot control system according to the first example embodiment.

FIG. 5 is a flowchart schematically showing operations of a control part of a control apparatus in the robot control system according to the first example embodiment.

FIG. 6 is a flowchart schematically showing operations of a control part of a leader robot in the robot control system according to the first example embodiment.

FIG. 7 is a flowchart schematically showing operations of a control part of a follower robot in the robot control system according to the first example embodiment.

FIG. 8 is an image diagram for explaining an error between a calculated current location at the time of acquiring second control information based on a first control information and an actual current location at the time of acquiring the second control information, when acquiring control information of a mobile robot in a robot control system according to a second example embodiment.

FIG. 9 is a graph for explaining how to adjust a base velocity of a mobile robot in the robot control system of the second example embodiment.

FIG. 10 is a flowchart schematically showing detailed operations at the time of calculation of a control value of a drive part of a control part of a mobile robot in the robot control system according to the second example embodiment.

FIG. 11 is a block diagram schematically showing a configuration of a robot control system according to a third example embodiment.

FIG. 12 is a flowchart schematically showing operations of a control part of a control apparatus in the robot control system according to the third example embodiment.

FIG. 13 is a flowchart schematically showing operations of a control part of a control apparatus in a robot control system according to a fourth example embodiment.

FIG. 14 is a block diagram schematically showing a configuration of a robot control system according to a fifth example embodiment.

FIG. 15 is a block diagram schematically showing a configuration of hardware resources.

### MODES

In the present disclosure described below, a robot control system according to Mode 1 and its modification mode(s) can be appropriately selected and combined.

As the robot control system according to Mode 1, a robot control system can be configured to comprise: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein the control apparatus executes processings of: generating control information including information related to a current location and an intermediate destination of each of the plurality of mobile robots at the same timing based on information from the sensor apparatus; and transmitting the generated control information to each of the plurality of mobile robots, wherein a leader robot in the plurality of mobile robots executes processings of: calculating a control value of the leader robot by using the information related to the current location and the intermediate destination of the leader robot in the control information; and controlling a movement of the leader robot based on the calculated control value of the leader robot, and wherein a follower robot(s) other than the leader robot in the plurality of mobile robots executes processings of: calculating a control value of the leader robot by using the information related to the current location and the intermediate destination of the leader robot in the control information; calculating a control value of the follower robot(s) by using the calculated control value of the leader robot and the information related to the current location and the intermediate destination of the follower robot(s) in the control information; and controlling a movement of the follower robot(s) so as to follow the leader robot based on the calculated control value of the follower robot(s).

As a modification mode of the robot control system according to Mode 1, the robot control system can be configured such that the sensor apparatus executes processings of: detecting a current location of each of the plurality of mobile robots at the same timing based on sensor information obtained by sensing the plurality of mobile robots in the predetermined area; and transmitting information related to the current location of each of the plurality of mobile robots at the same timing to the control apparatus, and wherein the control apparatus, in the processing of generating the control information, executes processings of: acquiring the information related to the current location of each of the plurality of mobile robots at the same timing from the sensor apparatus; calculating the intermediate destination of each of the plurality of mobile robots based on the information related to the current location and a final destination set in advance; and generating the control information including the information related to the current location, the intermediate destination, and the final destination of each of the plurality of mobile robots.

As a modification mode of the robot control system according to Mode 1, the robot control system can be configured such that the sensor apparatus executes processing of transmitting the sensor information obtained by sensing the plurality of mobile robots in the predetermined area to the control apparatus, and wherein the control apparatus, in the processing of generating the control information, executes processings of: detecting the current location of each of the plurality of mobile robots at the same timing based on the sensor information; calculating the intermediate destination of each of the plurality of mobile robots based on the information related to the current location and the information related to the final destination set in advance; and generating the control information including the information related to the current location, the intermediate destination, and the final destination of each of the plurality of mobile robots.

As a modification mode of the robot control system according to Mode 1, the robot control system can be configured such that in the processing of calculating the control value of the leader robot in the leader robot and the processing of calculating the control value of the leader robot in the follower robot, processings are executed, the processings being processings of: calculating a current location on calculation of the leader robot when acquiring second control information next to first control information as the control information based on first control information; calculating a movement error between the current location on calculation of the leader robot and the current location of the leader robot included in the second control information; calculating a base velocity of the leader robot by using the calculated movement error; and calculating the control value of the leader robot by using the calculated base velocity of the leader robot, and the calculated current location and the calculated intermediate destination of the leader robot included in the second control information, and wherein in the processing of calculating the base velocity, a processing is executed, the processing being a processing of calculating the base velocity so that a speed becomes lower as the movement error becomes larger.

As a modification mode of the robot control system according to Mode 1, the robot control system can be configured such that in the processing of calculating the base velocity, a movement error in x-axis direction, a movement error in y-axis direction, and an angle error in a traveling direction in the calculated movement error are adjusted by weighting. As a modification mode of the robot control system according to Mode 1, the robot control system can be configured such that in the processing of calculating the base velocity, the weighting is changed according to a curvature of an orbit of the leader robot.

In the present disclosure, a robot control system according to Mode 2 and its modification mode can be appropriately selected and combined.

As the robot control system according to Mode 2, a robot control system can be configured to comprise: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein he control apparatus executes processings of: calculating a control value of a leader robot in the plurality of mobile robots by using information related to a current location and an intermediate destination of each of the plurality of robots at the same timing based on information from the sensor apparatus; calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s).

As a modification mode of the robot control system according to Mode 2, the control system can be configured such that the processing of calculating the control value of the leader robot comprises processings of: calculating a calculated current location of the leader robot when acquiring information relating to a second current location next to a first current location as the current location based on information related to the first current location; calculating a movement error between the calculated current location of the leader robot and the second current location of the leader robot; calculating a base velocity of the leader robot by using the calculated movement error; and calculating the control value of the leader robot by using information related to the calculated base velocity, the calculated second current location and the calculated intermediate destination of the leader robot, wherein in the processing of calculating the base velocity, the base velocity is calculated so that a speed becomes lower as the movement error becomes larger.

As a control apparatus according to Mode 3, a control apparatus in a robot control system, can be configured such that the robot control system comprises: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein the control apparatus executes processings of: generating control information including information related to a current location and an intermediate destination of each of the plurality of mobile robots at the same timing based on information from the sensor apparatus; and transmitting the generated control information to each of the plurality of mobile robots.

As a control apparatus according to Mode 4, a control apparatus in a robot control system, can be configured such that the robot control system comprises: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein the control apparatus executes processings: calculating a control value of a leader robot in the plurality of mobile robots by using information related to a current location and an intermediate destination of each of the plurality of robots at the same timing based on information from the sensor apparatus; calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

As a mobile robot according to Mode 5, a mobile robot in a robot control system, can be configured such that the robot control system comprises: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein when the mobile robot becomes a follower robot(s) other than a leader robot in the plurality of mobile robots, the mobile robot executes processings of: acquiring control information including information related to a current location and an intermediate destination of each of the plurality of mobile robots at the same timing based on the information from the sensor apparatus, from the control apparatus; calculating a control value of the leader robot by using the information related to the current location and the intermediate destination of the leader robot in the control information; calculating a control value of the follower robot(s) by using the calculated control value of the leader robot and the information related to the current location and the intermediate destination of the follower robot(s) in the control information; and controlling a movement of the follower robot(s) so as to follow the leader robot based on the calculated control value of the follower robot(s).

As a robot control method according to Mode 6, a robot control method of controlling a plurality of mobile robots by using a robot control system, can be configured such that the robot control system comprises: a plurality of mobile robots; a control apparatus that is communicably connected to the plurality of mobile robots and manages and controls the plurality of mobile robots; and a sensor apparatus that is communicably connected to the control apparatus and senses the plurality of mobile robots in a predetermined area, wherein the method comprises: in the control apparatus, generating control information including information related to a current location and an intermediate destination of each of the plurality of mobile robots at the same timing based on information from the sensor apparatus; in the control apparatus, transmitting the generated control information to each of the plurality of mobile robots; in a leader robot in the plurality of mobile robots, calculating a control value of the leader robot by using the information related to the current location and the intermediate destination of the leader robot in the control information; in the leader robot, controlling a movement of the leader robot based on the calculated control value of the leader robot; in a follower robot(s) other than the leader robot in the plurality of mobile robots, calculating a control value of the leader robot by using the information related to the current location and the intermediate destination of the leader robot in the control information; in the follower robot(s), calculating a control value of the follower robot by using the calculated control value of the leader robot and the information related to the current location and the intermediate destination of the follower robot(s) in the control information; and in the follower robot(s), controlling a movement of the follower robot(s) so as to follow the leader robot based on the calculated control value of the follower robot(s).

As a program according to Mode 7, a program causing a control apparatus in a robot control system to execute processings, can be configured such that the robot control system comprises: a plurality of mobile robots; the control apparatus that is communicably connected to the plurality of mobile robots and manages and controls the plurality of mobile robots; and a sensor apparatus that is communicably connected to the control apparatus and senses the plurality of mobile robots in a predetermined area, wherein the program causes the control apparatus to execute the processings: generating control information including information related to a current location and an intermediate destination of each of the plurality of mobile robots at the same timing based on information from the sensor apparatus; and transmitting the generated control information to each of the plurality of mobile robots.

As a program according to Mode 8, a program causing a control apparatus in a robot control system to execute processings, can be configured such that the robot control system comprises: a plurality of mobile robots; the control apparatus that is communicably connected to the plurality of mobile robots and manages and controls the plurality of mobile robots; and a sensor apparatus that is communicably connected to the control apparatus and senses the plurality of mobile robots in a predetermined area, wherein the program causes the control apparatus to execute the processings: calculating a control value of a leader robot in the plurality of mobile robots by using information related to a current location and an intermediate destination of each of the plurality of mobile robots at the same timing based on information from the sensor apparatus; calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

As a program according to Mode 9, a program causing a control apparatus in a robot control system to execute processings, can be configured such that the robot control system comprises: a plurality of mobile robots; the control apparatus that is communicably connected to the plurality of mobile robots and manages and controls the plurality of mobile robots; and a sensor apparatus that is communicably connected to the control apparatus and senses the plurality of mobile robots in a predetermined area, wherein when the mobile robot becomes a follower robot(s) other than a leader robot in the plurality of mobile robots, the mobile robot executes processings of: acquiring control information including information related to a current location and an intermediate destination of each of the plurality of mobile robots at the same timing based on the information from the sensor apparatus, from the control apparatus; calculating a control value of the leader robot by using the information related to the current location and the intermediate destination of the leader robot in the control information; calculating a control value of the follower robot(s) by using the calculated control value of the leader robot and the information related to the current location and the intermediate destination of the follower robot(s) in the control information; and controlling a movement of the follower robot(s) so as to follow the leader robot based on the calculated control value of the follower robot(s).

Hereinafter, example embodiments will be described with reference to drawings. When drawing-reference signs are attached in the present application, they are solely for the purpose of assisting understanding, and are not intended to be limited to the illustrated modes. Also, the following example embodiments are merely examples, and do not limit the present invention. Further, connecting lines between blocks such as drawings referred to in the following description includes both bidirectional and unidirectional. A one-way arrow schematically shows a flow of a main signal (data), and does not exclude bidirectional. Furthermore, in circuit diagrams, block diagrams, internal configuration diagrams, connection diagrams, etc. shown in the disclosure of the present application, although explicit disclosure is omitted, an input port and an output port exist at the input end and the output end of each connection line, respectively. The same applies to the input/output interface. A program is executed via a computer apparatus, which comprises, for example, a processor, a storage device, an input device, a communication interface, and a display device as required, and the computer apparatus is configured to be able to communicate with inside device(s) or external apparatus(es) (including computer(s)) via a communication interface regardless of whether it is wired or wireless.

### First Example Embodiment

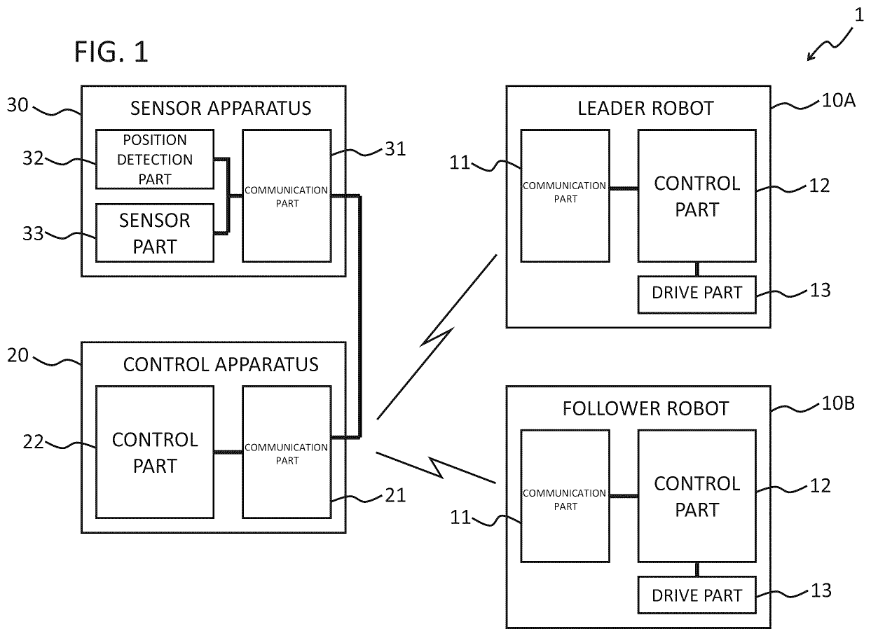

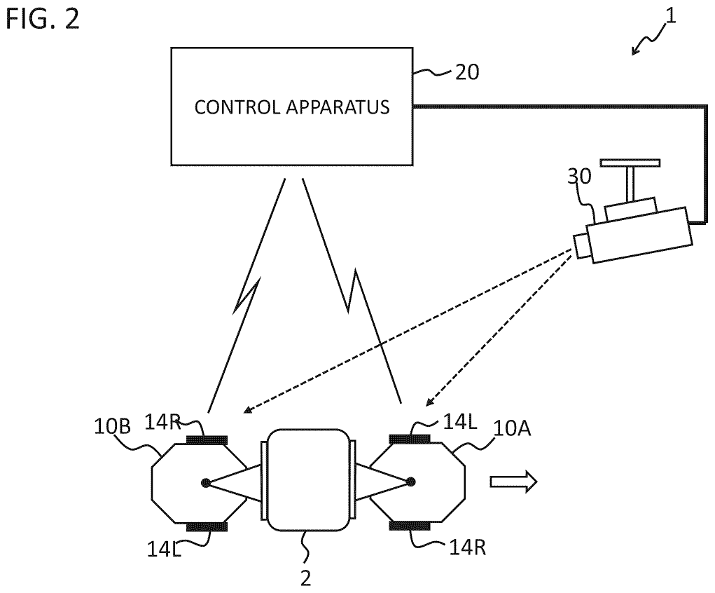

A robot control system according to a first example embodiment will be described with reference to drawings. FIG. 1 is a block diagram schematically showing a configuration of the robot control system according to the first example embodiment. FIG. 2 is an image diagram schematically showing a state when a transport object is transported by using the robot control system according to the first example embodiment.

The robot control system 1 is a system that controls a plurality of mobile robots (leader robot 10A and follower robot 10B in FIG. 1) to move while cooperating (collaborating) (see FIG. 1). The robot control system 1 can be used as a transport system for transporting a transport object 2 in a state in which the transport object 2 (for example, a trolley loaded with freight) is sandwiched between the leader robot 10A and the follower robot 10B. (see FIG. 2). The robot control system 1 comprises: a leader robot 10A; a follower robot 10B; a control apparatus 20; and a sensor apparatus 30.

The leader robot 10A is a mobile robot that leads the follower robot 10B (see FIGS. 1 and 2). The follower robot 10B is a mobile robot that follows a movement of the leader robot 10A (see FIGS. 1 and 2). The leader robot 10A and the follower robot 10B are connected to the control apparatus 20 so as to be capable of wireless communication (wired communication is also possible). The leader robot 10A and the follower robot 10B move in cooperation with each other under a control of the control apparatus 20. As the leader robot 10A and the follower robot 10B, for example, it is possible to use a uniaxial two-wheel type mobile robot in which left and right wheels 14L, 14R for driving are substantially on one axis and a distance between the wheels 14L, 14R is constant (see FIG. 2). The leader robot 10A and the follower robot 10B can move in a circular motion or go straight. The leader robot 10A and the follower robot 10B may be configured so as not to stop to turn for smooth transportation. The leader robot 10A and the follower robot 10B may have the same configuration. The leader robot 10A and the follower robot 10B comprise: a communication part 11; a control part 12; a drive part 13; and wheels 14L, 14R.

The communication part 11 is a function part that enables communication with the control apparatus 20 (see FIG. 1). The communication part 11 is controlled by the control part 12.

The control part 12 is a function part that controls the drive part 13 based on the control information acquired from the control apparatus 20 (see FIG. 1). As the control part 12, for example, a control unit comprising a memory, a processor, and the like can be used. In this case, the control part may be configured to perform; a control processing; an information processing; and a calculation processing by executing a program in the processor while using the memory. The control part 12 can be communicably connected to the control apparatus 20 via the communication part 11. The control part 12 executes a processing of acquiring control information from the control apparatus 20. The control part 12 executes a processing of calculating a control value of the drive part 13 based on the acquired control information. The control part 12 executes a processing of controlling the drive part 13 based on the calculated control value. By controlling the drive part 13, the control part 12 can adjust a movement speed and a movement direction of the mobile robot (leader robot 10A, follower robot 10B). The control part 12 is attached to a main body of the mobile robot.

When operating as the leader robot 10A or when the mobile robot moves independently, the control part 12 acquires control information including information related to destinations (intermediate destination, final destination) and information related to a current location (position coordinates, direction), of each of the mobile robots (leader robot 10A, follower robot 10B) through the communication part 11 from the control apparatus 20, thereby, the control part 12 calculates a control value of the drive part 13 of itself (each mobile robot) based on the destination (destination coordinates, destination direction) and the current location, of itself, included in the control information; controls the drive part 13 of itself based on the calculated control value, and controls a movement of itself. Here, the destination of the follower robot 10B may be the same as the destination of the leader robot 10A.

When operating as the follower robot 10B, the control part 12 acquires control information including information related to destinations (intermediate destination, final destination) and information related to a current location, of each of the mobile robots (leader robot 10A, follower robot 10B) through the communication part 11 from the control apparatus 20, thereby, the control part 12 calculates a control value of the drive part 13 of the leader robot 10A based on the destinations of the leader robot 10A and the current location of the leader robot 10A included in the acquired control information; calculates a control value of the drive part 13 of the follower robot 10B of itself based on the calculated control value of the drive part 13 of the leader robot 10A, the destinations of the follower robot 10B of itself included in the control information, and the current location of the follower robot 10B of itself; controls the drive part 13 of the follower robot 10B of itself based on the calculated control value of the drive part 13 of the follower robot 10B of itself; and controls a movement of the follower robot 10B so as to follow the leader robot 10A.

The drive part 13 is a function part that drives the wheels (14L, 14R in FIG. 2) (see FIG. 1). As the drive part 13, for example, a drive part comprising a motor, a speed reducer, a driver, various sensors (current sensor, torque sensor, position sensor, etc.), a regulator, a shaft, and the like can be used. The drive part 13 is attached to a main body of the mobile robot. The drive part 13 separately outputs a rotation power on the left side and a rotation power on the right side. The rotation power on the left side of the drive part 13 can be transmitted to the wheel(s) 14L. The rotation power on the right side of the drive part 13 can be transmitted to the wheel(s) 14R.

The wheels 14L, 14R are driving wheels that realize a movement of the mobile robot (leader robot 10A, follower robot 10B) (see FIG. 2). The wheels 14L, 14R are separately driven by the drive part 13. The wheels 14L, 14R are arranged so as to be coaxial with each other. The wheels 14L, 14R may be arranged so as to be tilted (to have a camber angle), and may be designed so that an inclination fluctuates (so that a camber angle fluctuates) by using a suspension, a constant velocity joint, or the like.

The control apparatus 20 is a apparatus that manages and controls each of the mobile robots (leader robot 10A, follower robot 10B) (see FIGS. 1 and 2). The control apparatus 20 comprises a communication part 21 and a control part 22.

The communication part 21 is a function part that enables communication with the mobile robots (leader robot 10A, follower robot 10B) (see FIG. 1). The communication part 21 is communicably connected to the sensor apparatus 30. The communication part 21 is controlled by the control part 22.

The control part 22 is a function part that controls each of the mobile robots (leader robot 10A, follower robot 10B) (see FIG. 1). As the control part 22, for example, a computer apparatus comprising a memory, a processor, and the like can be used. In this case, the computer apparatus may be configured to perform: a control processing; an information processing; and a calculation processing by executing a program(s) in the processor while using the memory. The control part 22 can be communicably connected to each of the mobile robots (leader robot 10A, follower robot 10B) and the sensor apparatus 30 via the communication part 21. The control part 22 executes a processing of acquiring information related to the current location of each of the mobile robots (leader robot 10A, follower robot 10B) through the communication part 21 from the sensor apparatus 30. The control part 22 executes a processing of calculating an intermediate destination of each of the mobile robots (leader robot 10A, follower robot 101B) for moving each of the mobile robots from the current location to the final destination by a desired route based on the acquired information related to the current location of each of the mobile robots (leader robot 10A, follower robot 10B) and the information related to the final destination. The control part 22 executes a processing of generating control information including the information related to the current location and the destinations (including the intermediate destination and the final destination), of each of the mobile robots (leader robot 10A, follower robot 10B). The control part 22 executes a processing of transmitting the generated control information to each of the mobile robots (leader robot 10A, follower robot 10B) through the communication part 21.

The sensor apparatus 30 is an apparatus that senses a position of each of the mobile robots (leader robot 10A, follower robot 101B) in a predetermined area (see FIGS. 1 and 2). The sensor apparatus 30 comprises: a communication part 31; a position detection part 32; and a sensor part 33.

The communication part 31 is a function part that enables communication with the control apparatus 20 (see FIG. 1). The communication part 31 is controlled by the position detection part 32.

The position detection part 32 is a function part that detects a position of each of the mobile robots (leader robot 10A, follower robot 10B) (see FIG. 1). The position detection part 32 can use a computer apparatus comprising a memory, a processor, and the like. In this case, the computer apparatus may be configured to perform: a control processing; an information processing; and a calculation processing by executing a program(s) in the processor while using the memory. The position detection part 32 executes a processing of acquiring sensor information sensed by the sensor part 33 at a predetermined timing (preset sampling period; for example, several tens of ms (milliseconds)). The position detection part 32 executes a processing of detecting a current location of each of the mobile robots (leader robot 10A, follower robot 10B) at the same timing by image processing (for example, fining, high resolution, noise removal, low resolution, opening processing, morphology conversion, point group processing, etc.) based on the sensor information. The position detection part 32 executes a processing of transmitting information relating to the current location of each of the mobile robots (leader robot 10A, follower robot 10B) at the same timing to the control apparatus 20 through the communication part 31.

The sensor part 33 is a function part that senses a position of each of the mobile robots (leader robot 10A, follower robot 101B) in a predetermined area (see FIG. 1). As the sensor part 33, for example, a camera such as a visible camera, an infrared camera, a hyperspectral camera, and an RGB (Red Green Blue) camera; a depth sensors such as a laser scanner, a 2D (2-Dimensions) laser distance meter, a stereo camera, and a ToF (Time of Flight) sensor and LiDAR (Light Detection and Ranging) sensor; a three-dimensional sensor; or the like can be used. The sensor part 33 outputs the sensor information sensed by each of the mobile robots (leader robot 10A, follower robot 10B) toward the position detection part 32.

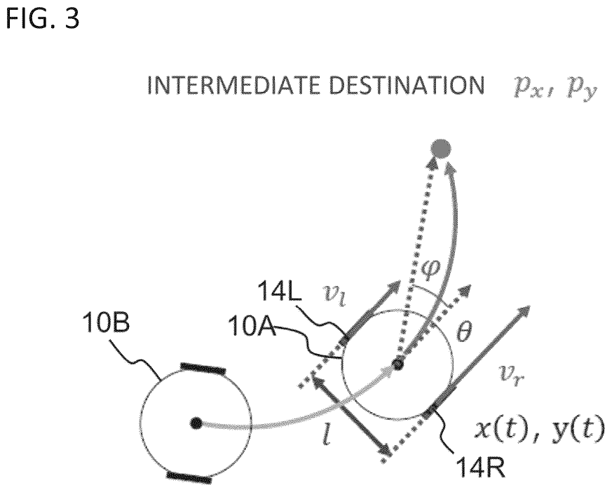

Next, an example of a method of calculating the control value of the drive part of the mobile robot in the robot control system according to the first example embodiment will be described with reference to drawings. FIG. 3 is an image diagram for explaining an example of a method of calculating the control value of the drive part of the mobile robot in the robot control system according to the first example embodiment. Here, a case in which the mobile robot (leader robot 10A, follower robot 10B) is a uniaxial two-wheel type mobile robot will be described.

Referring to FIG. 3, when the leader robot 10A aims from the current location (gravity center position) “(x(t), y(t))” at the time “t” of acquiring control information to the intermediate destination “(pₓ, p_{y})” and moves in a circular orbit at a base velocity “v_{base}”, if an angle of a traveling direction of the leader robot 10A at the time “t” of acquiring control information is “θ(t)”, and a distance between the left and right wheels of the leader robot 10A (distance between centers of a widths of the left and right wheels) is “1”, an angle φ formed by a traveling direction (tangential direction of circular orbit) of the leader robot 10A and a direction from the current location to the intermediate destination of the leader robot 10A, at the time “t” of acquiring control information; a distance “d” between the current location and the intermediate destination of the leader robot 10A; a velocity “vᵣ(t)” of the right wheel 14R of the leader robot 10A; and a rotation velocity “vₗ(t)” of the left wheel 14L of the leader robot 10A can be expressed as Formula 1, respectively. The follower robot 10B can calculate a control value (rotational speeds “(vᵣ(t), vₗ(t))” of the left and right wheels 14L, 14R) of the drive part 13 of the leader robot 10A, based on: an intermediate destination “(pₓ, p_{y})” of the leader robot 10A, a current location “(x(t), y(t))” of the leader robot 10A, and an angle “θ” in a traveling direction of the leader robot 10A, respectively; a base velocity “v_{base}” of the leader robot 10A; and a distance “1” between the left and right wheels of the leader robot 10A. So, the follower robot 10B can control the left and right wheels 14L, 14R by calculating a control value (rotation velocities “(vᵣ (t), yᵣ (t))” of the left and right wheels 14L, 14R) of the drive part 13 of the follower robot 10B of itself so as to follow the leader robot 10A according to the calculated control value of the drive part 13 of the leader robot 10A. The base velocity “v_{base}” can be set to a low speed and a speed can be decreased as a curvature of the circular orbit increases.

$$φ = 2 a tan ( {p}_{y} - y ( t ) , {p}_{x} - x ( t ) ) - 2 θ ( t ) \\ d = \sqrt{{( x ( t ) - {p}_{x} )}^{2} + {( y ( t ) - {p}_{y} )}^{2}} \\ {v}_{r} ( t ) = {v}_{base} [ 1 + \frac{l}{d} sin ( \frac{φ}{2} ) ] \\ {v}_{l} ( t ) = {v}_{base} [ 1 - \frac{l}{d} sin ( \frac{φ}{2} ) ] \qquad [ Formula 1 ]$$

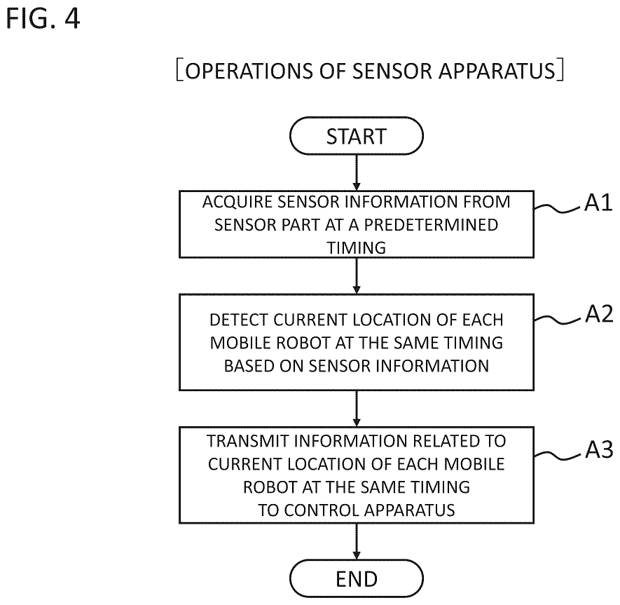

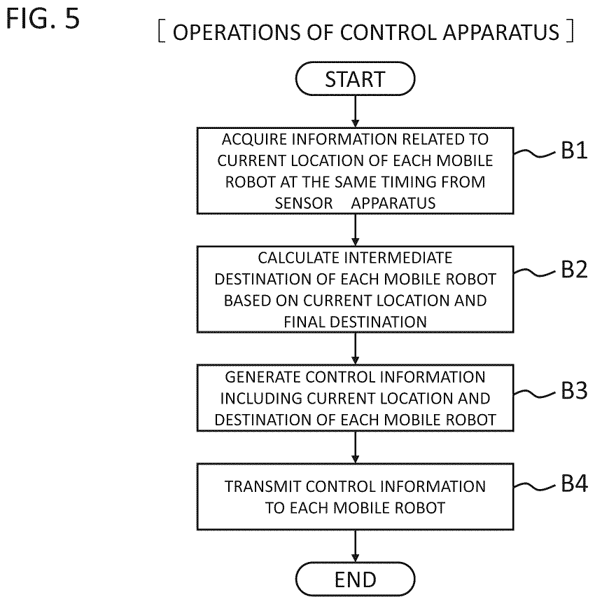

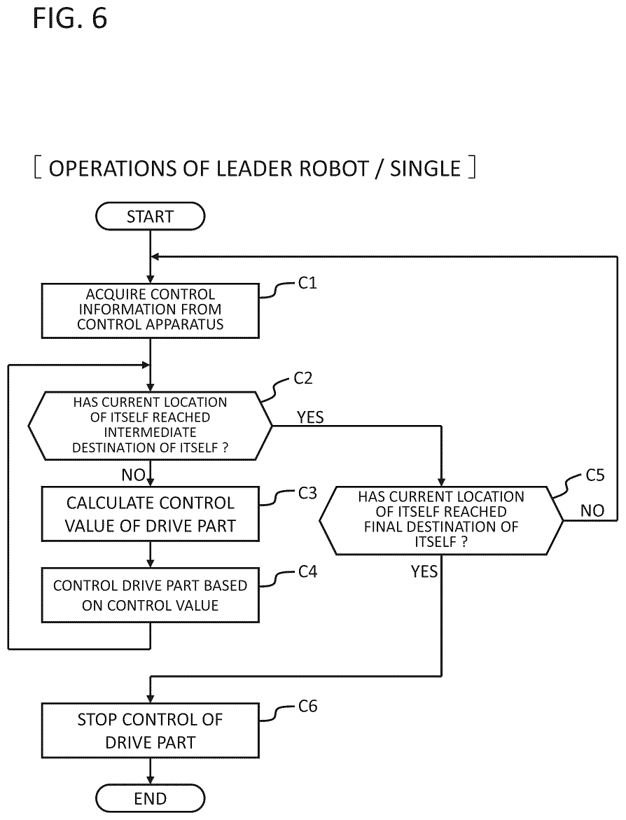

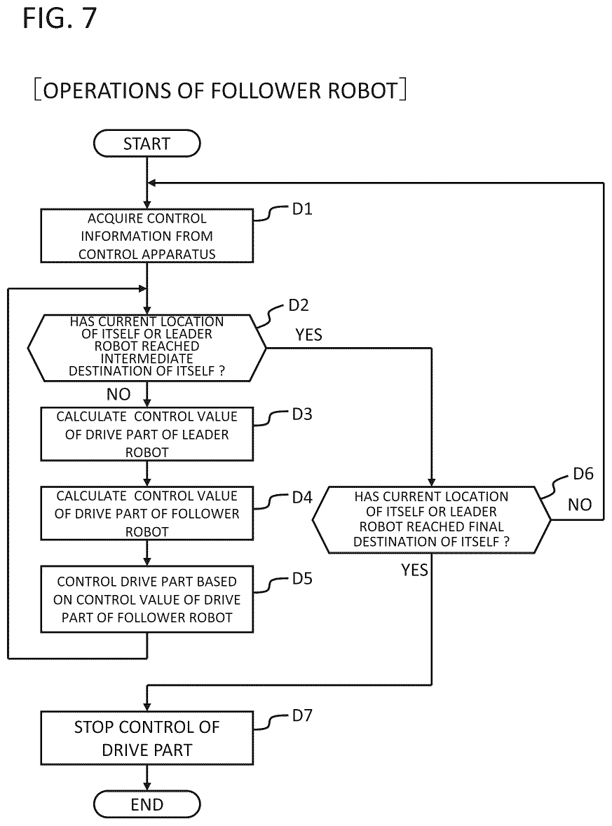

Next, operations of the robot control system according to the first example embodiment will be described with reference to drawings. FIG. 4 is a flowchart schematically showing operations of the position detection part of the sensor apparatus in the robot control system according to the first example embodiment. FIG. 5 is a flowchart schematically showing operations of the control part of the control apparatus in the robot control system according to the first example embodiment. FIG. 6 is a flowchart schematically showing operations of the control part of the leader robot in the robot control system according to the first example embodiment. FIG. 7 is a flowchart schematically showing operations of the control part of the follower robot in the robot control system according to the first example embodiment. Please refer to FIG. 1 about the configuration of the robot control system 1.

Operations of the position detection part 32 of the sensor apparatus 30 will be described.

Referring to FIG. 4, first, the position detection part 32 of the sensor apparatus 30 acquires sensor information from the sensor part 33 at a predetermined timing (preset sampling cycle) (Step A1). Here, the sensor information is information that the sensor part 33 senses each of the mobile robots (leader robot 10A, follower robot 10B) in a predetermined area.

Next, the position detection part 32 of the sensor apparatus 30 detects a current location of each of the mobile robots (leader robot 10A, follower robot 10B) at the same timing by performing image processing based on the acquired sensor information (Step A2).

Next, the position detection part 32 of the sensor apparatus 30 transmits information related to the detected current location of each of the mobile robots (leader robot 10A, follower robot 10B) at the same timing to the control apparatus 20 through the communication part 31 (Step A3). Then, the processing ends and returns to the start.

Operations of the control part 22 of the control apparatus 20 will be described.

Referring to FIG. 5, first, the control part 22 of the control apparatus 20 acquires information related to the current location of each of the mobile robots (leader robot 10A, follower robot 10B) at the same timing from the sensor apparatus 30 through the communication part 21 (Step B1).

Next, the control part 22 of the control apparatus 20 calculates an intermediate destination of each of the mobile robots (leader robot 10A, follower robot 10B) for moving each of the mobile robots (leader robot 10A, follower robot 10B) from the current location to the final destination by a desired route based on the acquired information related to the current location of each of the mobile robots (leader robot 10A, follower robot 10B) at the same timing and information related to the final destination (Step B2). Here, the information related to the final destination is information of the final destination input and set in the control apparatus 20 before controlling each of the mobile robots (leader robot 10A, follower robot 10B).

Next, the control part 22 of the control apparatus 20 generates control information including: information related to the current location of each of the mobile robots (leader robot 10A, follower robot 10B); and information related to the destinations (including the intermediate destination and the final destination) of each of the mobile robots (leader robot 10A, follower robot 10B) (Step B3).

Next, the control part 22 of the control apparatus 20 transmits the generated control information to each of the mobile robots (leader robot 10A, follower robot 10B) through the communication part 21 (Step B4). Then, the processing ends and returns to the start.

Operation of the control part 12 of the leader robot 10A will be described.

Referring to FIG. 6, first, or when the current location of the leader robot has not reached the final destination of itself (NO of Step C5), the control part 12 of the leader robot 10A acquires the control information including: the information related to the destination (including the intermediate destination and the final destination); and the information related to the current location of each of the mobile robots 10A and 10B from the control apparatus 20 through the communication part 11 (Step C1).

After Step C1 or after Step C4, the control part 12 of the leader robot 10A determines whether or not the current location of itself included in the control information has reached the intermediate destination (the nearest intermediate destination of itself in front) of itself included in the control information (Step C2). When the current location of itself has reached the intermediate destination of itself (YES of Step C2), the processing proceeds to Step C5.

When the current location of itself has not reached the intermediate destination of itself (NO of Step C2), the control part 12 of the leader robot 10A calculates a control value (for example, each rotation velocity of wheels 14L, 14R of FIG. 2) of the drive part 13 by using the control information (Step C3). As to the calculation of the control value, please refer to the above explanation in FIG. 3.

Next, the control part 12 of the leader robot 10A controls drive part 13 of itself based on the calculated control value (Step C4), and then the processing returns to Step C2.

When the current location of itself has reached the intermediate destination (YES of Step C2), the control part 12 of the leader robot 10A determines whether or not the current location of itself has reached the final destination of itself included in the control information (Step C5). If the current location of itself has not reached the final destination of itself (NO of Step C5), the processing returns to Step C1.

When the current location of itself has reached the final destination of itself (YES of Step C5), the control part 12 of the leader robot 10A stops the control of drive part 13 of itself (Step C6), and then the processing ends.

Operations of the control part 12 of the follower robot 10B will be described.

Referring to FIG. 7, first, or when the current location of the follower robot 10B itself or the leader robot 10A has not reached the final destination of itself (NO of Step D6), the control part 12 of the follower robot 10B acquires the control information including information related to the destinations (intermediate destination, final destination) of each of the mobile robots (leader robot 10A, follower robot 10B) and information related to the current location of each of the mobile robots (leader robot 10A, follower robot 10B) from the control apparatus 20 through the communication part 11 (Step D1).

After Step D1 or after Step D5, the control part 12 of the follower robot 10B determines whether or not the current location of the follower robot 10B itself or the leader robot 10A included in the control information has reached the intermediate destination (the nearest intermediate destination of itself in front) of itself included in the control information (Step D2). When the current location of the follower robot 10B itself or the leader robot 10A has reached the intermediate destination of itself (YES of Step D2), the processing proceeds to Step D6.

When the current location of the follower robot 10B itself or the leader robot 10A has not reached the intermediate destination of itself (NO of Step D2), the control part 12 of the follower robot 10B calculates a control value (for example, each rotation velocity of the wheels 14L, 14R in FIG. 2) of the drive part 13 of the leader robot 10A by using the intermediate destination of the leader robot 10A included in the acquired control information and the current location of the leader robot 10A (Step D3). As a result, the follower robot 10B can grasp a next movement of the leader robot 10A. As to the calculation of control value, please refer to the above explanation in FIG. 3.

Next, the control part 12 of the follower robot 10B calculates a control value (for example, each rotation velocity of the wheels 14L, 14R in FIG. 2) of the drive part 13 of the follower robot 10B itself by using the calculated control value of the drive part 13 of the leader robot 10A; the destination of the follower robot 10B itself included in the control information; and the current location of the follower robot 10B itself (Step D4). As to the calculation of control value, please refer to the above explanation in FIG. 3.

Next, the control part 12 of the follower robot 10B controls drive part 13 of itself based on the calculated control value of the drive part 13 of the follower robot 10B itself (Step D5), and then the processing returns to Step D2.

When the current location of the follower robot 10B itself or the leader robot 10A has reached the intermediate destination of the follower robot 10B itself (YES of Step D2), the control part 12 of the follower robot 10B determines whether or not the current location of the follower robot 10B itself or the leader robot 10A has reached the final destination of itself included in the control information (Step D6). When the current location of the follower robot 10B itself or the leader robot 10A has not reached the final destination of itself (NO of Step D6), the processing returns to Step D1.

When the current location of the follower robot 10B itself or the leader robot 10A has reached the final destination of the follower robot 10B itself (YES of Step D6), the control part 12 of the follower robot 10B stops controlling the drive part 13 of itself (Step D7), then the processing ends.

According to the first example embodiment, since the follower robot 10B grasps not only the destination and the current location of itself but also the destination and the current location of the leader robot 10A and the control value and calculates a control value of the follower robot 10B, it is possible to contribute to moving while maintaining synchronization between the mobile robots. Also, according to the first example embodiment, by the leader robot 10A and the follower robot 10B having the same configuration, since maintenance becomes easy, a cost can be reduced.

### Second Example Embodiment

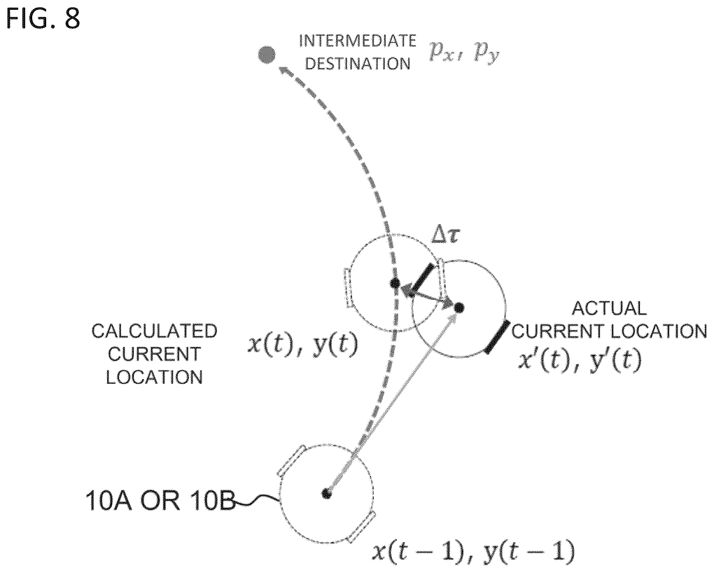

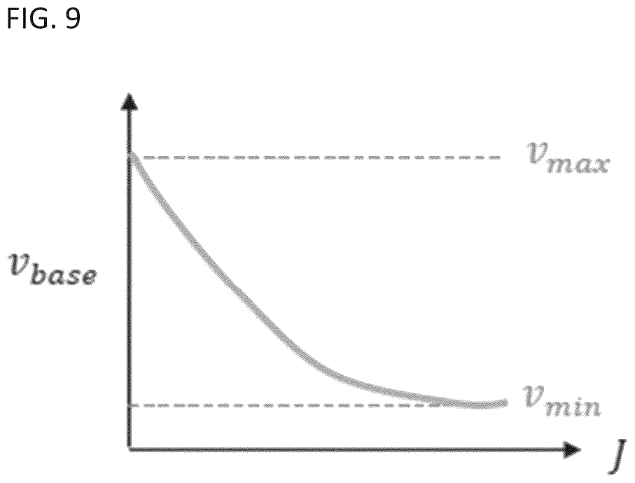

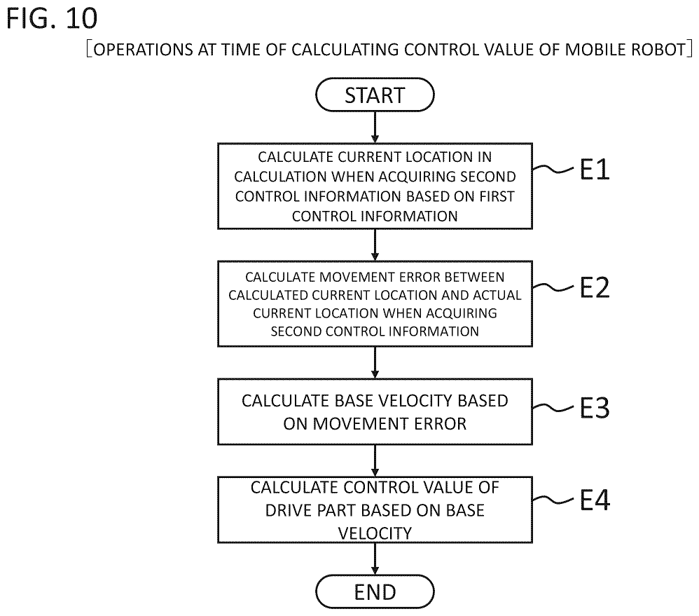

A robot control system according to a second example embodiment will be described with reference to drawings. FIG. 8 is an image diagram for explaining an error between a calculated current location at the time of acquiring second control information based on a first control information and an actual current location at the time of acquiring the second control information, when acquiring control information of a mobile robot in the robot control system according to the second example embodiment. FIG. 9 is a graph for explaining how to adjust a base velocity of a mobile robot in the robot control system of the second example embodiment. FIG. 10 is a flowchart schematically showing detailed operations at the time of calculation of a control value of a drive part of a control part of a mobile robot in the robot control system according to the second example embodiment.

The second example embodiment is a modification of the first example embodiment. Although a configuration of the robot control system according to the second example embodiment is the same as the configuration of the robot control system 1 according to the first example embodiment of FIG. 1, in the second example embodiment, the mobile robots (leader robot 10A, follower robot 10B) are configured so that a control value of the drive part is calculated at the time “t−1” of acquiring the first control information based on the first control information, and a movement control is performed from an actual current location “(x(t−1), y(t−1))” at the time “t−1” of acquiring the first control information, and then when a difference (movement error “Δτ”) between the calculated current location “(x(t), y(t))” at the time “t” of acquiring the second control information based on the first control information and the actual position (x′(t), y′(t)) at the time “t” of acquiring the second control information is large, a movement speed (base velocity “v_{base}”) is reduced (see FIG. 8).

That is, when the mobile robot (leader robot 10A, follower robot 10B) acquires the first control information at the time “t−1” of acquiring the first control information, and then acquires the second control information next to the first control information, the calculated current location “(x(t), y(t)” at the time “t” of acquiring the second control information of the moving robot (leader robot 10A, follower robot 10B) when moving from the time “t−1” of acquiring the first control information as calculated is compared with the actual current location (x′(t), y′(t)) at the time “t” of acquiring the second control information included in the second control information, and the movement speed (base velocity “v_{base}”) is set to decrease as their movement error “Δτ” increases. Here, the first control information includes: information related to the actual current location “(x(t−1), y(t−1))” of each of the mobile robots (leader robot 10A, follower robot 10B) at the time “t−1” of acquiring the first control information; and information related to the destinations (including the intermediate destination and the final destination) of each of the mobile robots (leader robot 10A, follower robot 10B). The second control information includes: information related to the actual current location (x′(t), y′(t)) of each of the mobile robots (leader robot 10A, follower robot 10B) at the time “t” of acquiring the second control information; and information related to the destinations (including the intermediate destination and the final destination) of each of the mobile robots (leader robot 10A, follower robot 10B).

A time difference between the time “t−1” of acquiring the control information and the time “t” of acquiring the control information is defined as “Δt”; rotation velocities of the left and right wheels of the mobile robot at the time “t−1” of acquiring the control information are defined as “(vᵣ(t−1), vₗ(t−1))”; an angle in a traveling direction of the mobile robot at the time “t−1” of acquiring the control information is defined as “θ(t−1)”; and a distance between the left and right wheels of the mobile robot (distance between centers of a width of each of the left and right wheels) is defined as “1”. In that case, the calculated current location “(x(t), y(t))” at the time “t” of acquiring the second control information and the angle “θ(t)” in the traveling direction can be represented as Formula 2 below.

$$x ( t ) = x ( t - 1 ) + Δ t \frac{{v}_{r} ( t - 1 ) + {v}_{l} ( t - 1 )}{2} cos [ θ ( t ) + \frac{{v}_{r} ( t - 1 ) - {v}_{l} ( t - 1 )}{2 l} Δ t ] \qquad [ Formula 2 ]$$

$$y ( t ) = y ( t - 1 ) + Δ t \frac{{v}_{r} ( t - 1 ) + {v}_{l} ( t - 1 )}{2} sin [ θ ( t ) + \frac{{v}_{r} ( t - 1 ) - {v}_{l} ( t - 1 )}{2 l} Δ t ]$$

$$θ ( t ) = θ ( t - 1 ) + \frac{{v}_{r} ( t - 1 ) - {v}_{l} ( t - 1 )}{l} Δ t$$

Also, the base velocity “v_{base}” of the mobile robot (leader robot 10A, follower robot 10B) can be adjusted by using Formula 3 below. As an error Δ^{T} between the actual current location and the calculated current location becomes larger, that is, “J”, which is an evaluation value of a movement error, becomes larger, the base velocity “v_{base}” is set so that a speed becomes lower, as shown in FIG. 9. Further, the base velocity “v_{base}” can be adjusted by weighting a movement error in the x direction; a movement error in the y direction; and an error of the angle “0” in the traveling direction due to a weight matrix “Q”. Furthermore, the weight matrix “Q” can change matrix components “q₁₁” to “q₆₆” (weighting coefficient) according to a curvature of an orbit of the mobile robot.

$$\begin{matrix}{v}_{base} = f ( J ) \\ = {e}^{- aJ} ( {v}_{max} - {v}_{min} ) + {v}_{min}\end{matrix} \\ J = {Δ}^{T} Q Δ \\ {Δ}^{T} = [ \begin{matrix}Δ {x}_{1} & Δ {y}_{1} & {Δθ}_{1} & Δ {x}_{2} & Δ {y}_{2} & {Δθ}_{2}\end{matrix} ] \\ Q = [ \begin{matrix}{q}_{11} & … & {q}_{16} \\ ⋮ & ⋱ & ⋮ \\ {q}_{61} & … & {q}_{66}\end{matrix} ] \qquad [ Formula 3 ]$$

Definitions of signs in Formula 3 are as follows.
α: Parameter that determines a degree of bending of the curve in FIG. 9.
J: Evaluation value of movement error
vₘₐₓ: Maximum value of base velocity
vₘᵢₙ: Minimum value of base velocity
Δ^{T}: Error between an actual current location and a calculated current location (transposed vector of error vector)
Δx₁: Positional error of “x” component of the leader robot (Δx₁=x₁ (t)−x₁′(t))
Δy₁: Positional error of “y” component of the leader robot (Δy₁=y₁(t)−y₁′(t))
Δθ₁: Angle error of “θ” component of the leader robot (Δθ₁=θ₁(t)−θ₁′(t))
Δx₂: Positional error of “x” component of the follower robot (Δx₂=x₂(t)−x₂′(t))
Δy₂: Positional error of “y” component of the follower robot

$$( Δ {y}_{2} = {y}_{2} ( t ) - {y}_{2}^{′} ( t ) )$$

Δθ₂: Angle error of “θ” component of the follower robot

$$( Δ {θ}_{2} = {θ}_{2} ( t ) - {θ}_{2}^{′} ( t ) )$$

Q: Weight matrix
“q₁₁” to “q₆₆”: Matrix component
Δ: Error vector

Although a configuration of the robot control system according to the second example embodiment is the same as the configuration of the robot control system according to the first example embodiment of FIG. 1, in the second example embodiment, the control part of the mobile robot (leader robot 10A, follower robot 10B) calculates a current location “(x(t), y(t))” in a calculation at the time “t” of acquiring the second control information based on the first control information; calculates a difference (movement error) between the calculated current location “(x(t), y(t))” in the calculation at the time “t” of acquiring the second control information and the actual current location (x′(t), y′(t)) at the time “t” of acquiring the second control information included in the second control information; calculates a base velocity “v_{base}” based on the calculated movement error; and calculates a control value of the drive part based on the base velocity “v_{base}”. At these points, the second example embodiment is different from the first example embodiment. In the calculation of the base velocity “v_{base}”, as the movement error becomes larger, the base velocity “v_{base}” is calculated so that a speed becomes lower.

Although operations of the robot control system according to the second example embodiment is the same as the operations of the robot control system according to the first example embodiment of FIGS. 4 to 7, in the second example embodiment, in the calculation of the control value of the drive part of Step C3 of FIG. 6 and the calculation of the control value of the drive part of the leader robot of Step D3 of FIG. 7, as shown in FIG. 10, a current location “(x(t), y(t))” in a calculation at the time “t” of acquiring the second control information based on the first control information is calculated (Step E1); a difference (movement error) between the calculated current location “(x(t), y(t))” in the calculation at the time “t” of acquiring the second control information and the actual current location (x′(t), y′(t)) at the time “t” of acquiring the second control information included in the second control information is calculated (Step E2); a base velocity “v_{base}” based on the calculated movement error is calculated (Step E3); and a control value of the drive part by using the calculated base velocity “v_{base}” and the second control information is calculated (Step E4). In these points, the second example embodiment is different from the first example embodiment. In the calculation of the base velocity “v_{base}”, as the movement error becomes larger, the base velocity “v_{base}” is calculated so that a speed becomes lower.

According to the second example embodiment, similarly to the first example embodiment, it is possible to contribute to reducing costs and causing to synchronize movement between robots, and it is possible to contribute to suppressing the movement error by monitoring the movement error between the calculated current location and the actual current location and adjusting the movement speed (base velocity “v_{base}”) so that a speed becomes lower as the movement error becomes larger, while the mobile robots (leader robot 10A, follower robot 10B) are moving.

### Third Example Embodiment

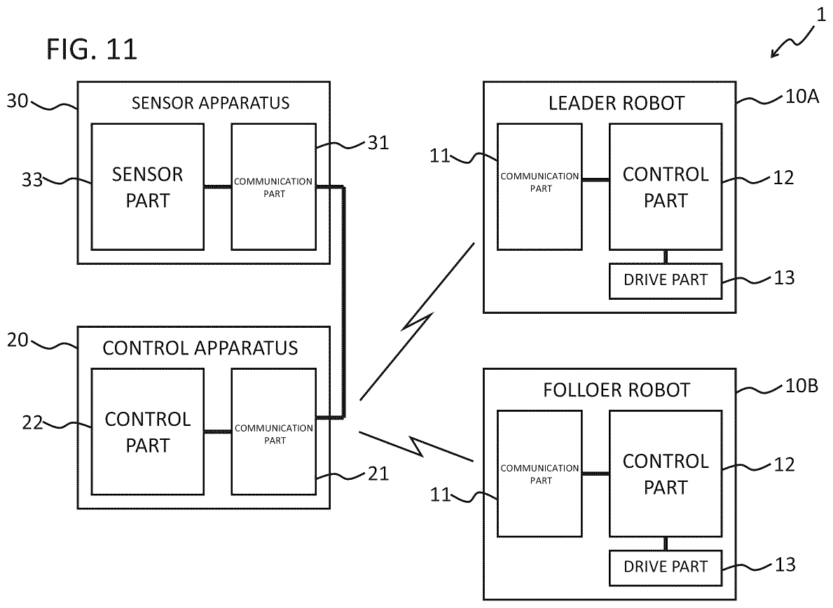

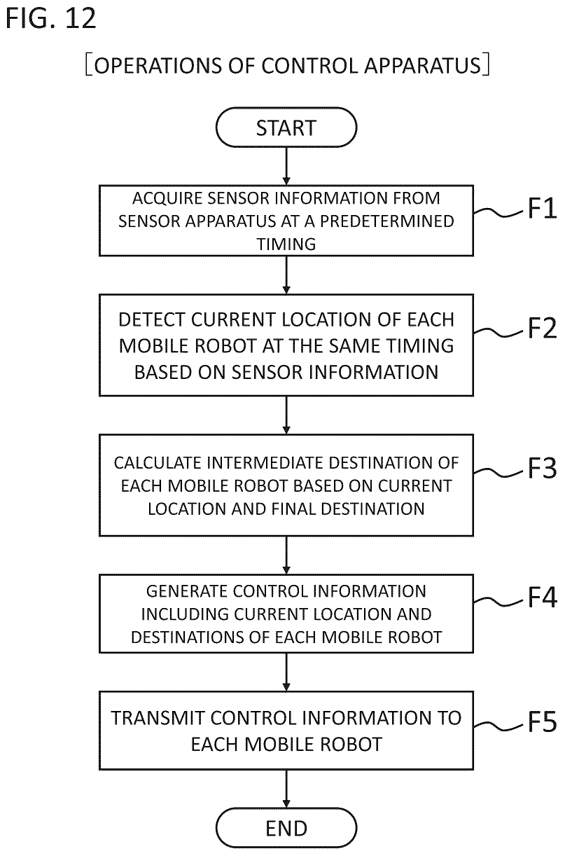

A robot control system according to a third example embodiment will be described with reference to drawings. FIG. 11 is a block diagram schematically showing a configuration of the robot control system according to the third example embodiment. FIG. 12 is a flowchart schematically showing operations of a control part of a control apparatus in the robot control system according to the third example embodiment.

The third example embodiment is a modification of the first example embodiment. The third example embodiment is configured so that in the sensor apparatus 30, the position detection part (32 in FIG. 1) is eliminated and various processings performed by the position detection part 32 in FIG. 1 are performed by the control part 22 of the control apparatus 20 (see FIG. 11).

The sensor apparatus 30 transmits the sensor information from the sensor part 33 to the control apparatus 20 through the communication part 31 without detecting the current location of each of the mobile robots.

The control part 22 of the control apparatus 20 can operate as shown in FIG. 12.

First, the control part 22 of the control apparatus 20 acquires sensor information from the sensor apparatus 30 at a predetermined timing (preset sampling cycle) (Step F1).

Next, the control part 22 of the control apparatus 20 detects the current location of each of the mobile robots (leader robot 10A, follower robot 10B) at the same timing by performing image processing based on the acquired sensor information (Step F2).

Next, the control part 22 of the control apparatus 20 calculates an intermediate destination of each of the mobile robots (leader robot 10A, follower robot 10B) for causing to move each of the mobile robots (leader robot 10A, follower robot 10B) from the current location to the final destination by a desired route based on the acquired information related to the current location of each of the mobile robots (leader robot 10A, follower robot 10B) at the same timing and information related to the final destination (Step F3).

Next, the control part 22 of the control apparatus 20 generates control information including information related to the current location of each of the mobile robots (leader robot 10A, follower robot 10B) and information related to the destinations (including the intermediate destination and the final destination) of each of the mobile robots (leader robot 10A, follower robot 10B) (Step F4).

Next, the control part 22 of the control apparatus 20 transmits the generated control information to each of the mobile robots (leader robot 10A, follower robot 10B) through the communication part 21 (Step F5). Then, the processing ends and returns to the start.

Other configuration and operations are similar to the first example embodiment. The third example embodiment can be applied to the second example embodiment.

According to the third example embodiment, similarly to the first example embodiment, it is possible to contribute to reducing costs and causing to synchronize movement between robots; the movement error can be suppressed; and by performing the processing related to the detection of the current location in the control apparatus 20, it is possible further to reduce costs accompanying the simplification of the configuration of the sensor apparatus 30.

### Fourth Example Embodiment

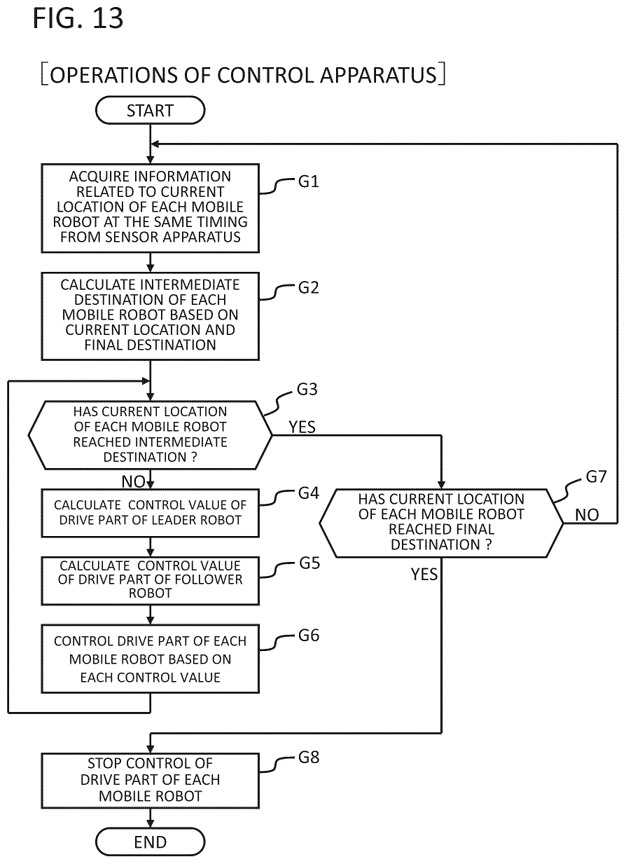

A robot control system according to a fourth example embodiment will be described with reference to drawings. FIG. 13 is a flowchart schematically showing operations of a control part of a control apparatus in the robot control system according to the fourth example embodiment.

The fourth example embodiment is a modification of the first example embodiment. Although a configuration of the robot control system according to the fourth example embodiment is the same as the configuration of the robot control system 1 according to the first example embodiment of FIG. 1, the fourth example embodiment is configured to perform the processing (excluding the control of the drive part 13) performed by the control part 12 of the mobile robot (leader robot 10A, follower robot 10B), by the control part 22 of the control apparatus 20. The control part 12 of the mobile robot (leader robot 10A, follower robot 10B) controls the drive part 13 according to the control of the control part 22 of the control apparatus 20, but does not perform other information processing.

The control part 22 of the control apparatus 20 can operate as shown in FIG. 13.

That is, first, or when the current location of each of the mobile robots has not reached the final destination (NO of Step G7), the control part 22 of the control apparatus 20 acquires information related to the current location of each of the mobile robots (leader robot 10A, follower robot 10B) at the same timing from the sensor apparatus 30 through the communication part 21 (Step G1).

Next, the control part 22 of the control apparatus 20 calculates an intermediate destination of each of the mobile robots (leader robot 10A, follower robot 10B) for moving each of the mobile robots (leader robot 10A, follower robot 10B) from the current location to the final destination by a desired route based on the acquired information related to the current location of each of the mobile robots (leader robot 10A, follower robot 10B) at the same timing and the information related to the final destination (Step G2).

After Step G2 or after Step G6, the control part 22 of the control apparatus 20 determines whether or not the current location of each of the mobile robots (leader robot 10A, follower robot 10B) has reached the intermediate destination (the nearest intermediate destination of itself in front) (Step G3). When the current location of each of the mobile robots has reached the intermediate destination (YES of Step G3), the processing proceeds to Step G7.

When the current location of each of the mobile robots has not reached the intermediate destination (NO of Step G3), the control part 22 of the control apparatus 20 calculates a control value (for example, each rotation velocity of the wheels 14L, 14R in FIG. 2) of the drive part 13 of the leader robot 10A by using the intermediate destination of the leader robot 10A and the current location of the leader robot 10A (Step G4).

Next, the control part 22 of the control apparatus 20 calculates a control value (for example, each rotation velocity of the wheels 14L, 14R in FIG. 2) of the drive part 13 by using the calculated control value of the drive part 13 of the leader robot 10A; the destinations of the follower robot 10B; and the current location of the follower robot 10B (Step G5).

Next, the control part 22 of the control apparatus 20 controls the drive part 13 of each of the mobile robots (leader robot 10A, follower robot 10B) based on the calculated control value of the drive part 13 of each of the mobile robots (leader robot 10A, follower robot 10B) (Step G6), and then the processing returns to Step G3.

When the current location of each of the mobile robots has reached the intermediate destination (YES of Step G3), the control part 22 of the control apparatus 20 determines whether or not the current location of each of the mobile robots (leader robot 10A, follower robot 10B) has reached the final destination (Step G7). When the current location of each of the mobile robots has not reached the final destination (NO of Step G7), the processing returns to Step G1.

When the current location of each of the mobile robots has reached the final destination (YES of Step G7), the control part 22 of the control apparatus 20 stops the control of the drive part 13 of each of the mobile robots (leader robot 10A, follower robot 10B) (Step G8) and then the processing ends.

Other configuration and operations are the same as the first example embodiment. The fourth example embodiment can also be applied to the second and third example embodiments.

According to the fourth example embodiment, similarly to the first example embodiment, it is possible to contribute to reducing costs and causing to synchronize movement between robots; it is possible to contribute to suppressing the movement error; it is possible further to reduce costs accompanying the simplification of the configuration of the sensor apparatus 30; and it is possible further to reduce costs accompanying the simplification of the configuration of the mobile robot (leader robot 10A, follower robot 10B) by performing the processing related to the calculation of the control value due to the control apparatus.

### Example Embodiment 5

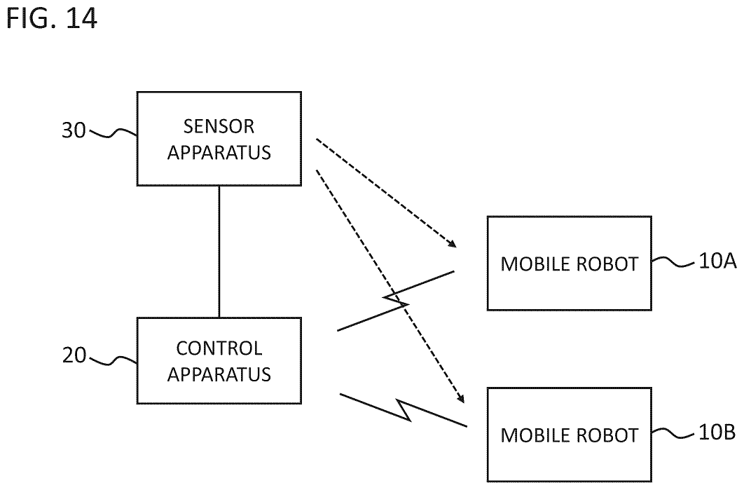

A robot control system according to a fifth example embodiment will be described with reference to drawings. FIG. 14 is a block diagram schematically showing a configuration of the robot control system according to the fifth example embodiment.

The robot control system 1 is a system comprising: a sensor apparatus 30; a control apparatus 20; and a plurality of mobile robots (leader robot 10A, follower robot 10B).

The sensor apparatus 30 is an apparatus that is communicably connected to the control apparatus 20 and senses the plurality of mobile robots (leader robot 10A, follower robot 10B) in a predetermined area.

The control apparatus 20 is an apparatus that is communicably connected to the plurality of mobile robots (leader robot 10A, follower robot 10B) and manages and controls the plurality of mobile robots (leader robot 10A, follower robot 10B). The control apparatus 20 executes a processing of generating control information including information related to a current location and an intermediate destination of each of the plurality of mobile robots (leader robot 10A, follower robot 10B) at the same timing based on information from the sensor apparatus 30. The control apparatus 20 executes a processing of transmitting the generated control information to each of the plurality of mobile robots.

The leader robot 10A among the plurality of mobile robots executes a processing of calculating a control value of the leader robot 10A by using the information related to the current location and the intermediate destination of the leader robot 10A in the control information. The leader robot 10A executes a processing of controlling a movement of the leader robot 10A based on the calculated control value of the leader robot 10A.

The follower robot 10B other than the leader robot 10A among the plurality of mobile robots executes a processing of calculating a control value of the leader robot 10A by using the information related to the current location and the intermediate destination of the leader robot 10A in the control information. The follower robot 10B executes a processing of calculating a control value of the follower robot 10B by using the calculated control value of the leader robot 10A and the information related to the current location and the intermediate destination of the follower robot 10B in the control information. The follower robot 10B executes a processing of controlling a movement of the follower robot 10B so as to follow the leader robot 10A based on the calculated control value of the follower robot 10B.

According to the fifth example embodiment, since the follower robot 10B grasps not only the destination and the current location of itself but also the destination and the current location of the leader robot 10A and the control value, and calculates the control value of the follower robot 10B, it is possible to contribute to moving while maintaining synchronization between the mobile robots. Also, according to the fifth example embodiment, since the leader robot 10A and the follower robot 10B have the same configuration, thereby, maintenance can be facilitated, costs can be reduced.

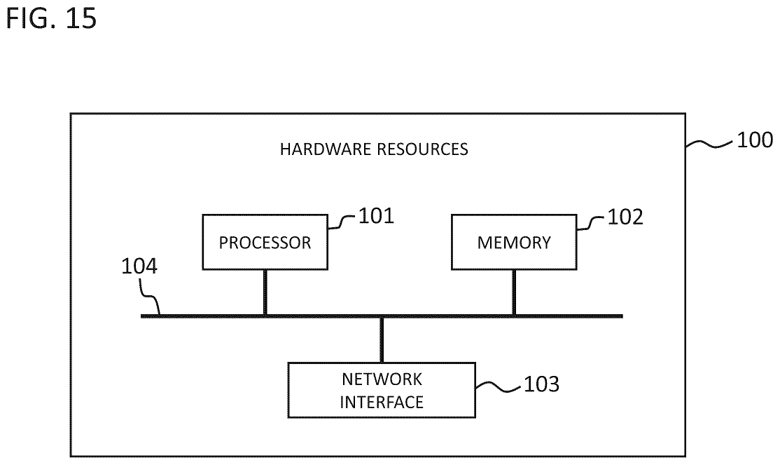

The control apparatuses according to the first to fifth example embodiments can be configured by so-called hardware resources (information processing apparatus, computer), and that having the configuration illustrated in FIG. 15 can be used. For example, the hardware resources 100 comprises: a processor 101; a memory 102; a network interface 103; and the like, which are connected to each other by an internal bus 104.

The configuration shown in FIG. 15 is not intended to limit a hardware configuration of the hardware resources 100. The hardware resources 100 may include hardware (for example, an input/output interface) (not shown). Alternatively, the number of units such as the processor 101 included in the apparatus is not limited to the example of FIG. 15, and for example, a plurality of processors 101 may be included in the hardware resources 100. As the processor 101, for example, a CPU (Central Processing Unit), an MPU (Micro Processor Unit), a GPU (Graphics Processing Unit), or the like can be used.

As the memory 102, for example, a RAM (Random Access Memory), a ROM (Read Only Memory), an HDD (Hard Disk Drive), an SSD (Solid State Drive), or the like can be used.

As the network interface 103, for example, a LAN (Local Area Network) card, a network adapter, a network interface card, or the like can be used.

Functions of the hardware resource 100 are realized by the above-mentioned processing module. The processing module is realized, for example, by the processor 101 executing a program stored in the memory 102. Also, the program can be downloaded via a network or updated using a storage medium in which the program is stored. Further, the processing module may be realized by a semiconductor chip. That is, the functions performed by the processing module may be realized by executing software on some hardware.

Part or all of the above example embodiments may be described as the following MODEs, but is not limited to the following.

### Mode 1

A robot control system, comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the control apparatus executes processings of:
generating control information including information related to a current location and an intermediate destination of each of the plurality of mobile robots at the same timing based on information from the sensor apparatus; and
transmitting the generated control information to each of the plurality of mobile robots,
wherein a leader robot in the plurality of mobile robots executes processings of:
calculating a control value of the leader robot by using the information related to the current location and the intermediate destination of the leader robot in the control information; and
controlling a movement of the leader robot based on the calculated control value of the leader robot, and
wherein a follower robot(s) other than the leader robot in the plurality of mobile robots executes processings of:
calculating a control value of the leader robot by using the information related to the current location and the intermediate destination of the leader robot in the control information;
calculating a control value of the follower robot(s) by using the calculated control value of the leader robot and the information related to the current location and the intermediate destination of the follower robot in the control information; and
controlling a movement of the follower robot(s) so as to follow the leader robot based on the calculated control value of the follower robot.

### Mode 2

The robot control system according to MODE 1, wherein the sensor apparatus executes processings of:
detecting a current location of each of the plurality of mobile robots at the same timing based on sensor information obtained by sensing the plurality of mobile robots in the predetermined area; and
transmitting information related to the current location of each of the plurality of mobile robots at the same timing to the control apparatus, and
wherein the control apparatus, in the processing of generating the control information, executes processings of:
acquiring the information related to the current location of each of the plurality of mobile robots at the same timing from the sensor apparatus; calculating the intermediate destination of each of the plurality of mobile robots based on the information related to the current location and a final destination set in advance; and
generating the control information including the information related to the current location, the intermediate destination, and the final destination of each of the plurality of mobile robots.

### Mode 3

The robot control system according to MODE 1,
wherein the sensor apparatus executes processing of transmitting the sensor information obtained by sensing the plurality of mobile robots in the predetermined area to the control apparatus, and
wherein the control apparatus, in the processing of generating the control information, executes processings of:
detecting the current location of each of the plurality of mobile robots at the same timing based on the sensor information;
calculating the intermediate destination of each of the plurality of mobile robots based on the information related to the current location and the information related to the final destination set in advance; and
generating the control information including the information related to the current location, the intermediate destination, and the final destination of each of the plurality of mobile robots.

### Mode 4

The robot control system according to any one of MODEs 1 to 3, wherein in the processing of calculating the control value of the leader robot in the leader robot and the processing of calculating the control value of the leader robot in the follower robot, processings are executed, the processings being processings of:
calculating a current location on calculation of the leader robot when acquiring second control information next to first control information as the control information based on first control information;
calculating a movement error between the current location on calculation of the leader robot and the current location of the leader robot included in the second control information;
calculating a base velocity of the leader robot by using the calculated movement error; and
calculating the control value of the leader robot by using the calculated base velocity of the leader robot, and the calculated current location and the calculated intermediate destination of the leader robot included in the second control information, and
wherein in the processing of calculating the base velocity, a processing is executed, the processing being a processing of calculating the base velocity so that a speed becomes lower as the movement error becomes larger.

### Mode 5

The robot control system according to MODE 4,
wherein in the processing of calculating the base velocity, the movement error in “x” direction, the movement error in “y” direction, and an angle error in a traveling direction in the calculated movement error are weighted and adjusted.

### Mode 6

The robot control system according to MODE 5,
wherein in the processing of calculating the base velocity, the weighting is changed according to a curvature of an orbit of the leader robot.

### Mode 7

A robot control system, comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the control apparatus executes processings of:
calculating a control value of a leader robot in the plurality of mobile robots by using information related to a current location and an intermediate destination of each of the plurality of mobile robots at the same timing based on information from the sensor apparatus;
calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

### Mode 8

The robot control system according to MODE 7,
wherein the processing of calculating the control value of the leader robot comprises processings of:
calculating a current location on calculation of the leader robot when acquiring information related to a second current location next to information related to a first current location as a current location based on information related to the first current location;
calculating a movement error between the calculated current location on calculation of the leader robot and the second current location of the leader robot;
calculating a base velocity of the leader robot by using the calculated movement error; and
calculating the control value of the leader robot by using the information related to the calculated base velocity, the calculated second current location and the calculated intermediate destination of the leader robot, and
wherein in the processing of calculating the base velocity, a processing is executed, the processing being a processing of calculating the base velocity so that a speed becomes lower as the movement error becomes larger.

### Mode 9

A control apparatus in a robot control system comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the control apparatus executes processings of:
generating control information including information related to a current location and an intermediate destination of each of the plurality of mobile robots at the same timing based on information from the sensor apparatus; and
transmitting the generated control information to each of the plurality of mobile robots.

### Mode 10

A control apparatus in a robot control system comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the control apparatus executes processings of:
calculating a control value of a leader robot in the plurality of mobile robots by using information related to a current location and an intermediate destination of each of the plurality of mobile robots at the same timing based on information from the sensor apparatus;
calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

### Mode 11

A mobile robot in a robot control system comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein when the mobile robot becomes a follower robot(s) other than a leader robot in the plurality of mobile robots, the mobile robot executes processings of:
acquiring control information including information related to a current location and an intermediate destination of each of the plurality of mobile robots at the same timing based on the information from the sensor apparatus, from the control apparatus;
calculating a control value of the leader robot by using the information related to the current location and the intermediate destination of the leader robot in the control information;
calculating a control value of the follower robot(s) by using the calculated control value of the leader robot and the information related to the current location and the intermediate destination of the follower robot in the control information; and
controlling a movement of the follower robot(s) so as to follow the leader robot based on the calculated control value of the follower robot(s).

### Mode 12

A robot control method of controlling a plurality of mobile robots by using a robot control system comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the method comprises:
in the control apparatus, generating control information including information related to a current location and an intermediate destination of each of the plurality of mobile robots at the same timing based on information from the sensor apparatus;
in the control apparatus, transmitting the generated control information to each of the plurality of mobile robots;
in a leader robot in the plurality of mobile robots, calculating a control value of the leader robot by using the information related to the current location and the intermediate destination of the leader robot in the control information;
in the leader robot, controlling a movement of the leader robot based on the calculated control value of the leader robot;
in a follower robot(s) other than the leader robot in the plurality of mobile robots, calculating a control value of the leader robot by using the information related to the current location and the intermediate destination of the leader robot in the control information;
in the follower robot(s), calculating a control value of the follower robot(s) by using the calculated control value of the leader robot and the information related to the current location and the intermediate destination of the follower robot(s) in the control information; and in the follower robot(s), controlling a movement of the follower robot(s) so as to follow the leader robot based on the calculated control value of the follower robot(s).

### Mode 13

A program causing a control apparatus in a robot control system to execute processings,
wherein the robot control system comprises:
a plurality of mobile robots;
the control apparatus that is communicably connected to the plurality of mobile robots and manages and controls the plurality of mobile robots; and
a sensor apparatus that is communicably connected to the control apparatus and senses the plurality of mobile robots in a predetermined area, and
wherein the program causes the control apparatus to execute the processings:
generating control information including information related to a current location and an intermediate destination of each of the plurality of mobile robots at the same timing based on information from the sensor apparatus; and
transmitting the generated control information to each of the plurality of mobile robots.

### Mode 14

A program causing a control apparatus in a robot control system to execute processings,
wherein the robot control system comprises:
a plurality of mobile robots;
the control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the program causes the control apparatus to execute the processings:
calculating a control value of a leader robot in the plurality of mobile robots by using information related to a current location and an intermediate destination of each of the plurality of mobile robots at the same timing based on information from the sensor apparatus;
calculating a control value of a follower robot(s) other than the leader robot in the plurality of mobile robots by using the calculated control value of the leader robot and the information related to the current location and the intermediate destination of the follower robot(s); and controlling movements of the leader robot and the follower robot(s) based on the calculated control values of the leader robot and the follower robot(s), respectively.

### Mode 15

A program causing a mobile robot in a robot control system to execute processings,
wherein the robot control system comprises:
the plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein when the mobile robot becomes a follower robot(s) other than a leader robot in the plurality of mobile robots, the program causes the mobile robot to execute the processings:
acquiring control information including information related to a current location and an intermediate destination of each of the plurality of mobile robots at the same timing based on the information from the sensor apparatus, from the control apparatus;
calculating a control value of the leader robot(s) by using the information related to the current location and the intermediate destination of the leader robot in the control information;
calculating a control value of the follower robot(s) by using the calculated control value of the leader robot and the information related to the current location and the intermediate destination of the follower robot(s) in the control information; and
controlling a movement of the follower robot(s) so as to follow the leader robot based on the calculated control value of the follower robot(s).

It should be noted that each disclosure of the above PTLs shall be incorporated and described herein by reference and can be used as a basis or a part of the present invention as necessary. Within a framework of the entire disclosure of the present invention (including claims and drawings), it is possible to modify or adjust the example embodiments or examples further based on the basic technical concept thereof. Also, within the framework of entire disclosure of the present invention, various combinations or selections (non-selection if necessary) of various disclosed elements (including each element of each claim, each element of each example embodiment or example, each element of each drawing, etc.) is possible. That is, it goes without saying that the present invention includes various deformations and modifications that can be made by one skilled in the art in accordance with all disclosures including claims and drawings, and the technical concept. Further, as to the numerical values and numerical ranges described in the present application, it is considered that arbitrary intermediate values, lower numerical values, and small ranges are described even if not explicitly recited. Furthermore, it is also considered that a matter used to combine part or all of each of the disclosed matters of the above-cited documents with the matters described in this document as a part of the disclosure of the present invention, in accordance with the gist of the present invention, if necessary, is included in the disclosed matters of the present application.

### REFERENCE SIGNS LIST

1 Robot control system
2 Transport object
10A Leader robot (mobile robot)
10B Follower robot (mobile robot)
11 Communication part
12 Control part
13 Drive part
14L, 14R Wheel
20 Control apparatus
21 Communication part
22 Control part
30 Sensor apparatus
31 Communication part
32 Position detection part
33 Sensor part
100 Hardware resources
101 Processor
102 Memory
103 Network interface
104 Internal bus

What is claimed is:

1. A robot control system, comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the control apparatus executes:
generating control information including information related to a current location and an intermediate destination of each of the plurality of mobile robots at the same timing based on information from the sensor apparatus; and
transmitting the generated control information to each of the plurality of mobile robots,
wherein a leader robot in the plurality of mobile robots executes:
calculating a control value of the leader robot by using the information related to the current location and the intermediate destination of the leader robot in the control information; and
controlling a movement of the leader robot based on the calculated control value of the leader robot, and
wherein a follower robot(s) other than the leader robot in the plurality of mobile robots executes:
calculating a control value of the leader robot by using the information related to the current location and the intermediate destination of the leader robot in the control information;
calculating a control value of the follower robot(s) by using the calculated control value of the leader robot and the information related to the current location and the intermediate destination of the follower robot(s) in the control information; and
controlling a movement of the follower robot(s) so as to follow the leader robot based on the calculated control value of the follower robot(s).

2. The robot control system according to claim 1,
wherein the sensor apparatus executes:
detecting a current location of each of the plurality of mobile robots at the same timing based on sensor information obtained by sensing the plurality of mobile robots in the predetermined area; and
transmitting information related to the current location of each of the plurality of mobile robots at the same timing to the control apparatus, and
wherein the control apparatus, in the generating the control information, executes:
acquiring the information related to the current location of each of the plurality of mobile robots at the same timing from the sensor apparatus;
calculating the intermediate destination of each of the plurality of mobile robots based on the information related to the current location and a final destination set in advance; and
generating the control information including the information related to the current location, the intermediate destination, and the final destination of each of the plurality of mobile robots.

3. The robot control system according to claim 1,
wherein the sensor apparatus executes transmitting the sensor information obtained by sensing the plurality of mobile robots in the predetermined area to the control apparatus, and
wherein the control apparatus, in the generating the control information, executes:
detecting the current location of each of the plurality of mobile robots at the same timing based on the sensor information;
calculating the intermediate destination of each of the plurality of mobile robots based on the information related to the current location and the information related to the final destination set in advance; and
generating the control information including the information related to the current location, the intermediate destination, and the final destination of each of the plurality of mobile robots.

4. The robot control system according to claim 1,
wherein the calculating the control value of the leader robot in the leader robot and the calculating the control value of the leader robot in the follower robot comprise:
calculating a current location on calculation of the leader robot when acquiring second control information next to first control information as the control information based on first control information;
calculating a movement error between the current location on calculation of the leader robot and the current location of the leader robot included in the second control information;
calculating a base velocity of the leader robot by using the calculated movement error; and
calculating the control value of the leader robot by using the calculated base velocity of the leader robot, and the calculated current location and the calculated intermediate destination of the leader robot included in the second control information, and
wherein the calculating the base velocity comprises calculating the base velocity so that a speed becomes lower as the movement error becomes larger.

5-8. (canceled)

9. A robot control method of controlling a plurality of mobile robots by using a robot control system comprising:
a plurality of mobile robots;
a control apparatus that is communicably connected to the plurality of mobile robots and manages and controls the plurality of mobile robots; and
a sensor apparatus that is communicably connected to the control apparatus and senses the plurality of mobile robots in a predetermined area,
wherein the method comprises:
in the control apparatus, generating control information including information related to a current location and an intermediate destination of each of the plurality of mobile robots at the same timing based on information from the sensor apparatus;
in the control apparatus, transmitting the generated control information to each of the plurality of mobile robots;
in a leader robot in the plurality of mobile robots, calculating a control value of the leader robot by using the information related to the current location and the intermediate destination of the leader robot in the control information;
in the leader robot, controlling a movement of the leader robot based on the calculated control value of the leader robot;
in a follower robot(s) other than the leader robot in the plurality of mobile robots, calculating a control value of the leader robot by using the information related to the current location and the intermediate destination of the leader robot in the control information;
in the follower robot(s), calculating a control value of the follower robot(s) by using the calculated control value of the leader robot and the information related to the current location and the intermediate destination of the follower robot(s) in the control information; and
in the follower robot(s), controlling a movement of the follower robot(s) so as to follow the leader robot based on the calculated control value of the follower robot(s).

10. A non-transient computer readable recording medium storing a program causing a control apparatus in a robot control system to execute processings,
wherein the robot control system comprises:
a plurality of mobile robots;
the control apparatus that is communicably connected to the plurality of mobile robots and manages and controls the plurality of mobile robots; and
a sensor apparatus that is communicably connected to the control apparatus and senses the plurality of mobile robots in a predetermined area, and
wherein the program causes the control apparatus to execute:
generating control information including information related to a current location and an intermediate destination of each of the plurality of mobile robots at the same timing based on information from the sensor apparatus; and
transmitting the generated control information to each of the plurality of mobile robots.

11. The robot control system according to claim 2,
wherein the calculating the control value of the leader robot in the leader robot and the calculating the control value of the leader robot in the follower robot comprise:
calculating a current location on calculation of the leader robot when acquiring second control information next to first control information as the control information based on first control information;
calculating a movement error between the current location on calculation of the leader robot and the current location of the leader robot included in the second control information;
calculating a base velocity of the leader robot by using the calculated movement error; and
calculating the control value of the leader robot by using the calculated base velocity of the leader robot, and the calculated current location and the calculated intermediate destination of the leader robot included in the second control information, and
wherein the calculating the base velocity comprises calculating the base velocity so that a speed becomes lower as the movement error becomes larger.

12. The robot control system according to claim 3,
wherein the calculating the control value of the leader robot in the leader robot and the calculating the control value of the leader robot in the follower robot comprise:
calculating a current location on calculation of the leader robot when acquiring second control information next to first control information as the control information based on first control information;
calculating a movement error between the current location on calculation of the leader robot and the current location of the leader robot included in the second control information;
calculating a base velocity of the leader robot by using the calculated movement error; and
calculating the control value of the leader robot by using the calculated base velocity of the leader robot, and the calculated current location and the calculated intermediate destination of the leader robot included in the second control information, and
wherein the calculating the base velocity comprises calculating the base velocity so that a speed becomes lower as the movement error becomes larger.

13. The robot control system according to claim 4,
wherein in the calculating the base velocity, the movement error in “x” direction, the movement error in “y” direction, and an angle error in a traveling direction in the calculated movement error are weighted and adjusted.

14. The robot control system according to claim 11,
wherein in the calculating the base velocity, the movement error in “x” direction, the movement error in “y” direction, and an angle error in a traveling direction in the calculated movement error are weighted and adjusted.

15. The robot control system according to claim 12,
wherein in the calculating the base velocity, the movement error in “x” direction, the movement error in “y” direction, and an angle error in a traveling direction in the calculated movement error are weighted and adjusted.

16. The robot control system according to claim 13,
wherein in the calculating the base velocity, the weighting is changed according to a curvature of an orbit of the leader robot.

17. The robot control system according to claim 14,
wherein in the calculating the base velocity, the weighting is changed according to a curvature of an orbit of the leader robot.

18. The robot control system according to claim 15,
wherein in the calculating the base velocity, the weighting is changed according to a curvature of an orbit of the leader robot.

19. The robot control method according to claim 9,
wherein the method further comprises:
in the sensor apparatus, detecting a current location of each of the plurality of mobile robots at the same timing based on sensor information obtained by sensing the plurality of mobile robots in the predetermined area; and
in the sensor apparatus, transmitting information related to the current location of each of the plurality of mobile robots at the same timing to the control apparatus, and
wherein the generating the control information comprises:
in the control apparatus, acquiring the information related to the current location of each of the plurality of mobile robots at the same timing from the sensor apparatus;
in the control apparatus, calculating the intermediate destination of each of the plurality of mobile robots based on the information related to the current location and a final destination set in advance; and
in the control apparatus, generating the control information including the information related to the current location, the intermediate destination, and the final destination of each of the plurality of mobile robots.

20. The robot control method according to claim 9,
wherein the method further comprises in the sensor apparatus, transmitting the sensor information obtained by sensing the plurality of mobile robots in the predetermined area to the control apparatus, and
wherein the generating the control information comprises:
in the control apparatus, detecting the current location of each of the plurality of mobile robots at the same timing based on the sensor information;
in the control apparatus, calculating the intermediate destination of each of the plurality of mobile robots based on the information related to the current location and the information related to the final destination set in advance; and
in the control apparatus, generating the control information including the information related to the current location, the intermediate destination, and the final destination of each of the plurality of mobile robots.

21. The robot control method according to claim 9,
wherein the calculating the control value of the leader robot in the leader robot, and the calculating the control value of the leader robot in the follower robot comprise:
calculating a current location on calculation of the leader robot when acquiring second control information next to first control information as the control information based on first control information;
calculating a movement error between the current location on calculation of the leader robot and the current location of the leader robot included in the second control information;
calculating a base velocity of the leader robot by using the calculated movement error; and
calculating the control value of the leader robot by using the calculated base velocity of the leader robot, and the calculated current location and the calculated intermediate destination of the leader robot included in the second control information, and
wherein the calculating the base velocity comprises calculating the base velocity so that a speed becomes lower as the movement error becomes larger.

22. The robot control method according to claim 9,
wherein the calculating the base velocity comprises weighting and adjusting the movement error in “x” direction, the movement error in “y” direction, and an angle error in a traveling direction in the calculated movement error.

23. The non-transient computer readable recording medium according to claim 10,
wherein the generating the control information comprises:
acquiring the information related to a current location of each of the plurality of mobile robots at the same timing from the sensor apparatus;
calculating the intermediate destination of each of the plurality of mobile robots based on the information related to the current location and a final destination set in advance; and
generating the control information including the information related to the current location, the intermediate destination, and the final destination of each of the plurality of mobile robots, and
wherein the information related to the current location of each of the plurality of mobile robots at the same timing to the control apparatus, is information detected based on sensor information obtained by sensing the plurality of mobile robots in the predetermined area due to the sensor apparatus.

24. The non-transient computer readable recording medium according to claim 10,
wherein the generating the control information comprises:
in the control apparatus, detecting the current location of each of the plurality of mobile robots at the same timing based on a sensor information;
in the control apparatus, calculating the intermediate destination of each of the plurality of mobile robots based on the information related to the current location and the information related to the final destination set in advance; and
in the control apparatus, generating the control information including the information related to the current location, the intermediate destination, and the final destination of each of the plurality of mobile robots, and
wherein the sensor information is information obtained by sensing the plurality of mobile robots in the predetermined area due to the sensor apparatus.
